(19) United States
(12) Patent Application Publication
(10) Pub. No.: US 2016/0174746 A1
(43) Pub. Date: Jun. 23, 2016

(54) Laching Holder for Keys and Objects

(71) Applicant: Jonathan Charles Doyle, New York, NY (US)

(72) Inventor: Jonathan Charles Doyle, New York, NY (US)

(21) Appl. No.: 14/582,128

(22) Filed: Dec. 23, 2014

(51) Int. Cl. A47G 29/10; F16M 13/02; A47G 29/00

(52) U.S. Cl. CPC A47G 29/10; A47G 29/00; F16M 13/02

(57) ABSTRACT

A holder for keys or objects is provided. The holder having a latching part for keys can be used to removably place in or attach to a device such as a chain door guard. The holder having a latching part for objects can be used to removably place in or attach to a device such as a chain door guard. The latching part can be with one or more nubs, capable of removably attaching, latching, fastening, hooking, placing, penetrating, slotting or sliding into a device such as a chain door guard having a slot therein.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not applicable.

### BACKGROUND OF THE INVENTIONS

1. Field of Invention

The present invention relates to a latching holder for keys or objects. More specifically, the present invention relates to a holder having a latch part for holding keys or objects. The invention has the ability to removably latch to a device such as a chain door guard having a slot therein.

2. Related Art

Key chains for everyday personal use come in many forms. Some key chains have loops. Some key chains come with alarm and light. Some key chains have detachable key ring or separable key chain. Some key chains come with a button connection type. Some key chains come with USB memory as well. A related art is a key chain that attaches to a person's clothing via a clasp, clamp or button. Clearly, the main purpose of a key chain is to hold keys and other objects.

It is known in the art to provide a basic key chain with added features to make the key chain to have added use.

A particular problem faced by a user of a key chain is that the key chain can be easily misplaced. Further, other everyday personal objects, such as cell phones, credit cards, money clips, and other things are easily misplaced. The use of conventional key chains or storage of personal objects are limited in certain respects, as they are typically placed on table tops, bowls, or shelves to store them in a location where they are not as visible and can be left behind. Unfortunately, the user may spend valuable time in search of the key chain or other objects. Thus, it would be desirable to provide a holder for keys or objects having a feature that allows the holder to be placed at a convenient location that allows easy retrieval. Accordingly, the present invention addresses these needs by providing a holder with a latching part.

One of the objects of the invention is to provide a means for affording a personal storage solution for keys and objects with the use of the holder by removably attaching it into a device such as a chain door guard having a slot therein.

Another object of the invention is to provide a latching holder for keys or objects that can be conveniently detach from a device such as a chain door guard having a slot therein and removably attachable thereto so that a user of the holder having a latching part can use it without being unduly restricted in the original use of the door chain and chain door guard having a slot therein.

Another object of the invention is a latching holder allows it to be slid into and out from a device such as a chain door guard having a slot therein.

A benefit of the present invention for keys and objects being slotted on a device such as a chain door guard having a slot therein is that it will allow a user of the holder to organize their primary personal effects, such as keys, wallets, paper money, credit cards, travel card, cell phones and other objects, in a location that is directly tied to the comings and goings of its place of living and enable the storage and direct access to the personal items that are typically carried with them outside of its personal living environment.

### BRIEF SUMMARY OF THE INVENTION

The present invention relates to holders for keys or objects, such as cell phones, credit cards, money clips, and other objects, are provided so that keys or personal objects are placed at a convenient location for easy retrieval.

In an embodiment of the present invention, a holder having a latching part that can hold keys can be placed to a device such as a chain door guard having a slot therein. An example of a latching part is a nub, wherein the nub can be in various sizes or shapes that can slide into a device such as a chain door guard having a slot therein.

In another embodiment of the present invention, a holder having one or more of nubs can slide into a device such as a chain door guard having a slot therein, wherein the holder can be used to store objects, such as keys, wallets, paper money, credit cards, travel card, cell phones and other objects.

In another embodiment of the present invention, a holder for keys or objects is can removably attach to another holder for keys or objects having a slot or hole that can accept a holder's nub to be removably attach.

In another embodiment of the present invention, a device such as a chain door guard having a slot therein can be re-appropriated for use to store objects in a location that is physically on the door by sliding the nub into the chain door guard having a slot therein found on the doors of homes and apartments by using a holder's nub.

### BRIEF DESCRIPTION OF THE SEVEAL VIEWS OF THE DRAWING

These and other important objects and features of the invention will be apparent from the following Detailed Description of the Invention, taken in connection with the drawings, in which:

FIG. 1A is a perspective view of an alternate embodiment of the present invention showing an angled view of a holder with the nub side.

FIG. 1B is a perspective view of an alternate embodiment of the present invention showing a side view of a holder having a nub.

FIG. 1C is perspective views of a preferred embodiment of the present invention showing top and side view of a nub.

FIG. 2A is a perspective view of an alternate embodiment of the present invention showing a holder with a nub being shown on the other side.

FIG. 2B is a perspective view of an alternate embodiment of the present invention showing a holder with a nub being shown on the same side.

FIG. 2C is a perspective view of an alternate embodiment of the present invention showing an angled view of a holder having a nub.

FIG. 3A is a perspective view of an alternate embodiment of the present invention showing a holder with nubs being shown on the same side.

FIG. 3B is a perspective view of an alternate embodiment of the present invention showing a holder with nubs being shown on the other side.

FIG. 3C is a perspective view of an alternate embodiment of the present invention showing a bottom view of a holder with nubs.

FIG. 3D is a perspective view of an alternate embodiment of the present invention showing a side view of a holder with nubs.

FIG. 3E is a perspective view of an alternate embodiment of the present invention showing a holder with nubs being shown on the same side.

FIG. 3F is a perspective view of an alternate embodiment of the present invention showing the other side of the view of FIG. 3E.

FIG. 4 is a perspective view of an alternate embodiment of the present invention showing a chain door guard placed on a door wherein in a nub can slide into a chain door guard having a slot therein.

### DETAILED DESCRIPTION OF THE INVENTION

Other and further objects, features and advantages of the invention will be hereinafter described and pointed out in the appended claims forming part of the application.

The invention pertains to the storage of everyday personal items via the sliding in and out of devices via a nub or nubs to devices such as a standard chain door guard having a slot therein. The ease of use of sliding into and out of a horizontal or vertical chain door guard having a slot therein via the nub provides easy storage of everyday personal items that either are attached to the personal item, can contain personal items or provides for the hanging of personal items.

As used herein, the term “chain” or “key chain” is intended to include any type of chains, strings, ribbons, braided wire, rings, and other commonly used items in the industry that may be employed in connection with a holder of the type herein referred to.

As used herein, the term “nub” is intended to mean any type of design where there is an enlarged head portion and a smaller cylinder portion. The cylinder referred in the smaller cylinder portion is generically used and can refer to other shapes, such as square or rectangular, and so on.

As used herein, the term “hole” or “slot” is interchangeably used and is intended to mean an opening of any size or shape.

As used herein, the term “detachable” or “separable” is interchangeably used and is intended to mean that a holder can be appropriated with a device such as a chain door guard for storage. For example, the latching part of a holder can be with one or more of nubs, capable of removably attaching, latching, fastening, hooking, placing, penetrating, slotting or sliding into a device such as a chain door guard having a slot therein, so that the holder can be detachable or separable from the device.

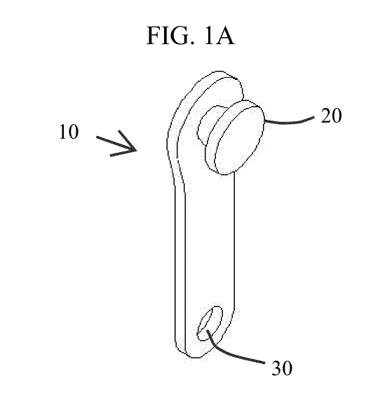

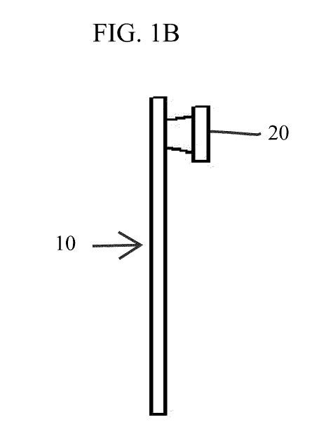

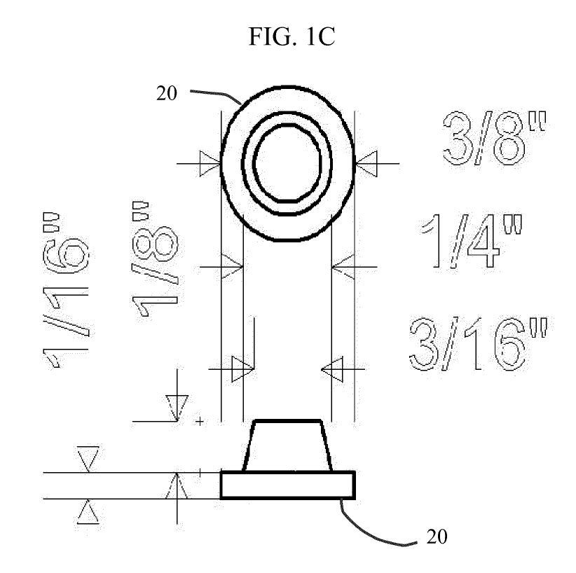

FIG. 1A is a diagram of an alternate embodiment of the present invention, generally indicated at an object holder 10. In this embodiment, the holder 10 shows a frame with a nub 20 attached to the upper portion of the frame and a hole or slot 30 is shown on the lower portion of the frame. The hole or slot may be any size or shape to allow keys or objects to clip on or latch on.

FIG. 1B is an alternate view of FIG. 1A, showing the side view of the present invention. The holder 10 generally shows the present invention, wherein the nub 20 is attached to the upper portion of the holder 10. It should be noted that the hole or slot 30 is not shown in this diagram because this side view does not allow the hole or slot 30 to be shown.

FIG. 1C is a diagram showing the preferred embodiment of the nub 20. FIG. 1C shows the dimensional measurements of the nub 20, showing the side view and the overhead view. The side view of FIG. 1C shows the enlarged head on the bottom and the cylinder on the top of the enlarged head. The overhead view of FIG. 1C shows the directional view from the side showing the cylinder. The nub 30 consists of the enlarged head having ⅜″ diameter circle that is 1/16″ thick that is attached on center to a ⅛″ tapered cylinder that varies in diameter from ¼″ to 3/16″. The enlarged head having ⅜″ diameter by 1/16″ thick diameter of the nub 20 is smaller in diameter than the typical chain door guard having a hole or slot therein. And, the chain door guard's hole or slot allows the nub 20 to penetrate, slot in, or slide into the typical chain door guard having a slot therein and then the nub 20 slots into the typical chain door guard having a slot therein. In conjunction with the tapered cylinder of the nub 20 that rests on the typical chain door guard having a slot therein, the enlarged head of the ⅜″ diameter circle that is 1/16″ thick diameter of the nub 20 keeps the nub 20 in place when used in conjunction with the holder 10. It should be noted that the cylinder does not need to be tapered.

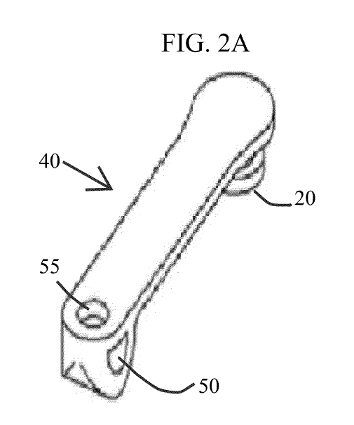

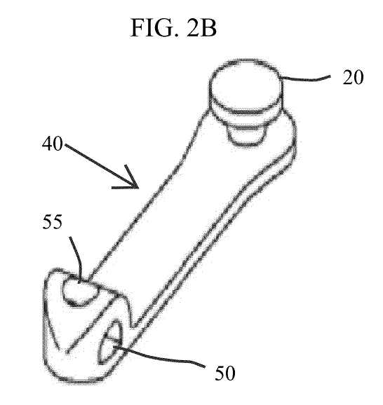

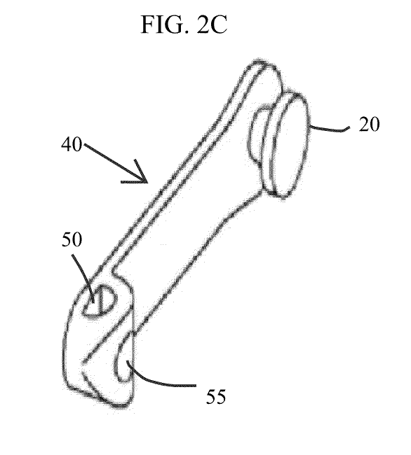

FIG. 2A is a diagram of an alternate embodiment of the present invention, generally indicated at an object holder 40. In this embodiment, the holder 40 shows a frame with a nub 20 attached to the upper portion of the frame of the holder 40 and the holes or slots 50 and 55 are shown on the lower portion of the frame. It should be noted that the holes 50 and 55 go all the way through the frame, thereby allowing the hole 50 and the hole 55 to intersect at a point within the frame of the object holder 40. When looking at the surface of the frame, there will appear to have four holes or slots, since the hole 50 and the hole 55 go through the frame from one side and leave from the opposite side. The holes or slots may be any size or shape to allow keys or objects to clip on or latch on.

FIG. 2B is an alternate view of FIG. 2A, showing the nub 20 side of the view, where the nub 20 is attached to the upper portion of the frame of the holder 40 and the holes or slots 50 and 55 are shown on the lower portion of the frame.

FIG. 2C is an alternate view of FIG. 2A, showing the side view of the frame of the holder 40, where the nub 20 is attached to the upper portion of the frame of the holder 40 and the holes or slots 50 and 55 are shown on the lower portion of the frame.

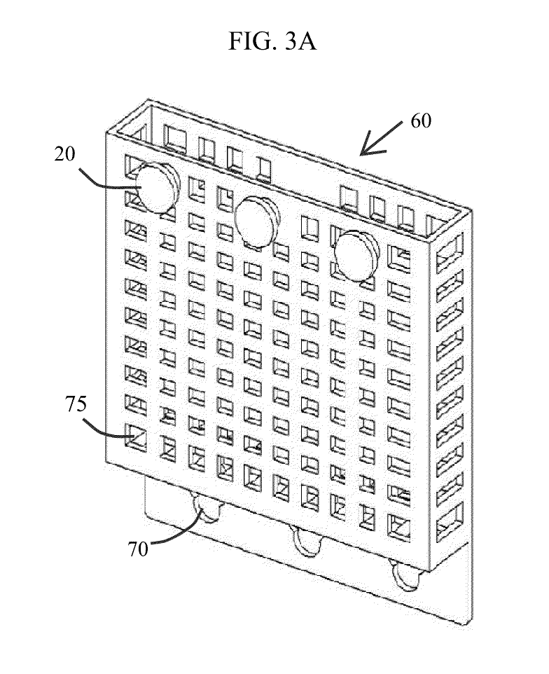

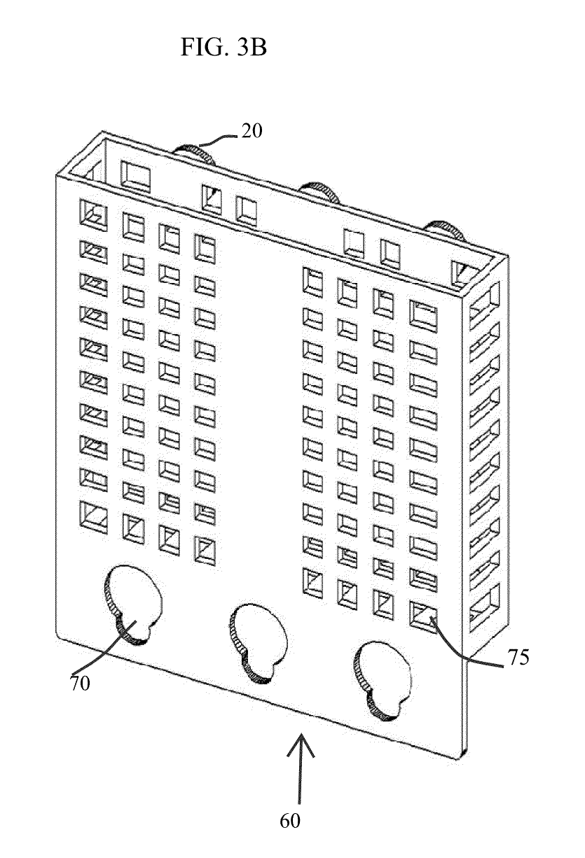

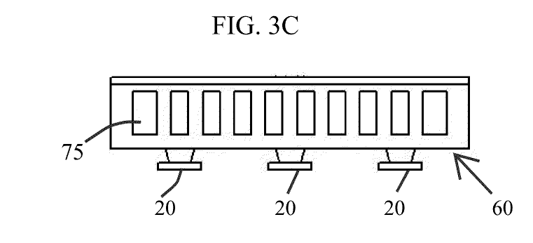

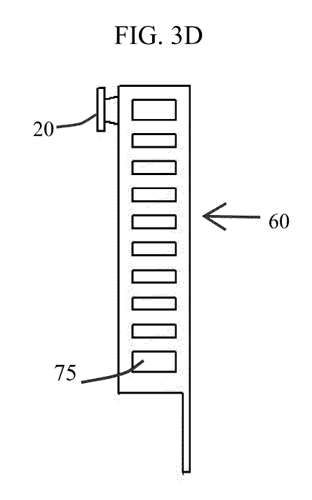

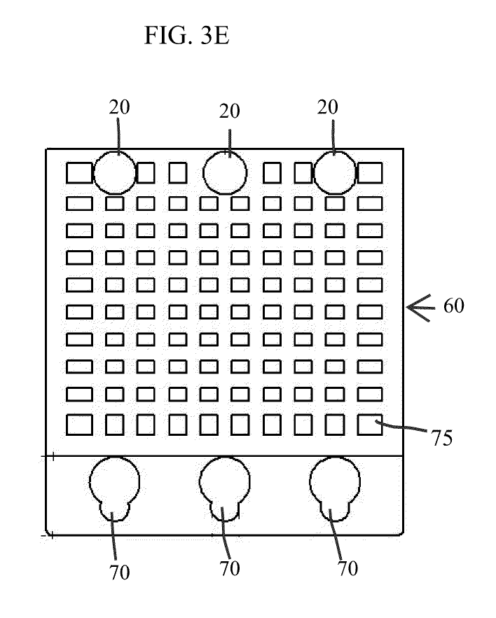

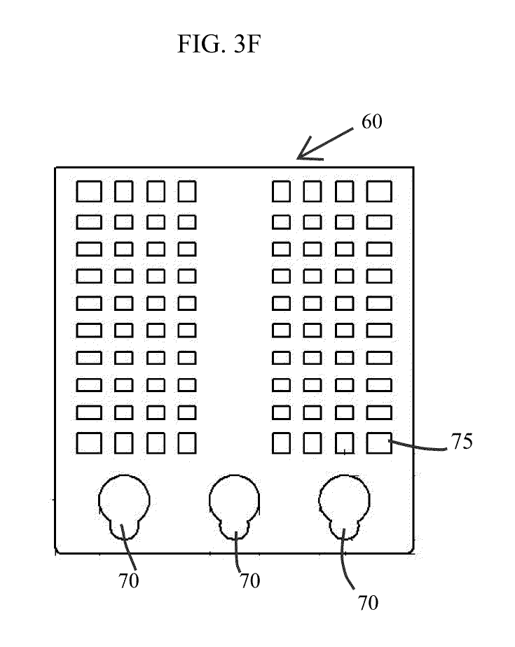

FIG. 3A is a diagram of an alternate embodiment of the present invention, generally indicated at an object holder 60, showing the backside of the holder 60. In this embodiment of the holder 60 having a container frame with three nubs 20 and three holes or slots 70, the three nubs 20 are attached to the top portion of the backside face of the container frame of the holder 60. The backside face has a standard dimension of 3 and ⅛″ wide by 2 and 11/16″ tall and the nubs 20 on the top side of that face are centered in a row and are equally spaced by 9/16″ apart or 15/16″ on center of each nub 20. The benefit of having three nubs 20 on the backside face is that it allows the holder 60 to slot into both a horizontal chain door guard having a slot therein in which all three nubs 20 would slot in, or in the instance of a vertical or diagonal chain door guard having a slot therein just the middle nub 20 that is centered on the backside face of the holder 60 would be used. The front side face of the holder 60 having the container frame has a standard dimension of 3⅛″ wide by 3⅜″ tall. On the bottom portion of the front side face of the holder 60 are three holes 70 that consist of a circular 7/16″ diameter primary hole or slot and a secondary circular ¼″ diameter hole or slot that is offset to create a cradle that would accept another holder 60 and allow for the hanging of multiple holders one hanging on the next via the nubs 20 or up to three holders 10 or 40 for keys or objects via the nub 20. The overall standard depth of the holder 60 that attaches to the three nubs is ⅝″, but that depth can vary based upon the needs of the personal items that need to be contained. The wall thickness of the holder 60 has a standard dimension of 1/16″ but could be thicker depending on the specific material properties. It should be noted that the size of the holder 60 is not limited to the width of a standard chain door guard. It could be wider, so long as the nub 20 can be utilized with a device such as the chain door guard. This holder 60 is found to have multiple square or rectangular holes 75 on the container frame. It should be noted that in another embodiment of the present invention, the container frame does not necessarily need to have multiple square or rectangular holes 75. In the figure, holes 75 are generally pointed to one hole, nubs 20 are generally pointed to one nub, and holes 70 are generally pointed to one hole.

FIG. 3B is an alternate view of FIG. 3A, showing the front side of the container frame of the holder 60. The nubs 20 are shown on the backside. The holes 70 are shown on the front side. The multiple square or rectangular holes 75 are shown on the container frame of the holder 60.

FIG. 3C is an alternate view of FIG. 3A, showing the bottom side of the view of the container frame of the holder 60. The nubs 20 are shown and the multiple square or rectangular holes 75 are shown.

FIG. 3D is an alternate view of FIG. 3A, showing the side view of the container frame of the holder 60. The nub 20 is shown and the multiple square or rectangular holes 75 are shown.

FIG. 3E is an alternate view of FIG. 3A, showing the back side view of the container frame of the holder 60. The nubs 20 are attached on the top portion of the container frame of the holder 60. The three holes or slots 70 are shown on the bottom portion of the front side face of the holder 60. It should be noted that said three holes or slots 70 can be placed or found on the lower portion of the container frame. The multiple square or rectangular holes 75 are shown.

FIG. 3F is an alternate view of FIG. 3A, showing the front side of the container frame of the holder 60. The three holes or slots 70 are shown on the bottom portion of the front side face of the holder. The multiple square or rectangular holes 75 are shown.

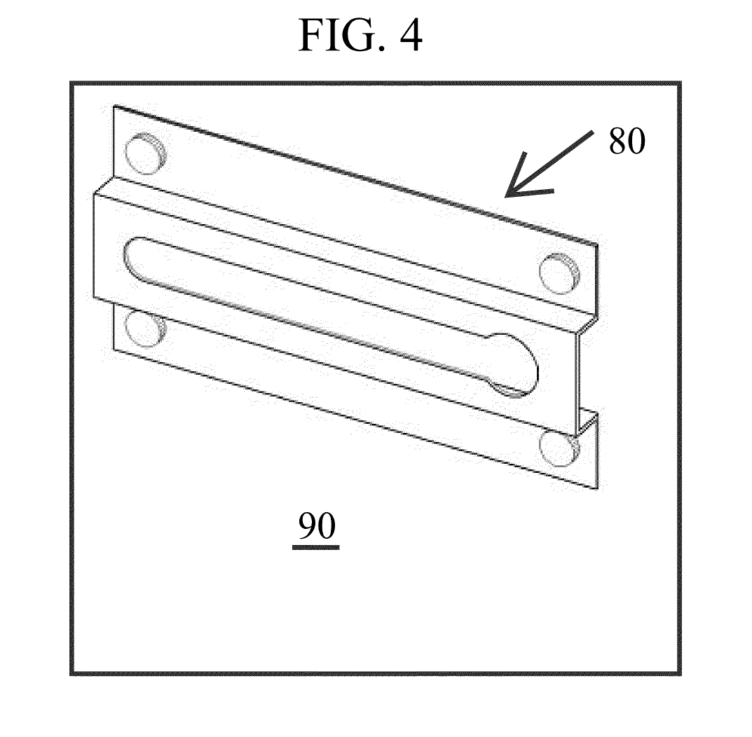

FIG. 4 is a diagram of a chain door guard 80, which is attached to a door 90.

In another embodiments of the holders 10 or 40, the length from the nub 20 and the holes or slots 30, 50 or 55 can vary, depending on the size of the frame of the holder 10 or 40. The two ends of the frame of the holder 10 or 40 are attached by a ⅜ wide rectangle that varies in length depending upon the size of the holder 10 or 40. The frame of the holder 10 or 40 has a standard thickness of 1/16″, but this could be thicker depending on the specific material properties. The frame's size may vary. The size of the nub may vary. And, the size of a device that accepts the nub may vary accordingly to accommodate or accept the size of the nub. Here, a chain door guard having a slot therein is an example of a device that accepts the nub is specifically referenced. However, any device that accommodate or accepts the nub or nubs can be used.

The overall length of the frame of the holder that is attached to the nub 20 is currently implemented in 6 overall lengths: 2½″, 2 3/16″, 1 13/16″, 1⅛″, 1⅛″ and 13/16″. The overall length of the frame may vary.

The various sizes of the holder face and nub combination will allow for the one off or bulk manufacturing of the keychain via 3D digital printing manufacturing methods in various materials, such as plastics, metals, ceramics and other materials that are normally used with different price points or via more traditional manufacturing methods such as injection molding in the instance of mass production quantities in plastics and metals.

The holder 60 and its three nubs 70 would be manufactured via 3D digital printing manufacturing methods in various materials, such as plastics, metals, ceramics and other materials that are normally used with different price points or via more traditional manufacturing methods such as injection molding in the instance of mass production quantities in plastics and metals.

The nub 20 is a feature of the holders 10, 40 and 60 that allows the holders 10, 40 and 60 to be used with a device such as a chain door guard having a slot therein. It should be noted that the dimensions of the holder 10, 40 and 60 can vary based upon the design and based upon the objects or items that need to be stored.

In another embodiment, the holders can be appropriated with a key chain. A key chain can be appropriated with the holders with various methods, including any type of chains, strings, ribbons, braided wire, rings, and other commonly used items in the industry, such as use of clamps, magnets, detachable rings or key chains as known in the art.

In another embodiment, the holders can be appropriated with other holders. Using a device having a hole therein, a holder with a nub can be appropriated.

What is claimed is:

1) An object holder comprising:
a) a nub; and
b) a frame having an upper portion and a lower portion, said upper portion being connected to said nub and said lower portion defining one or more holes therein.

2) The object holder of claim 1, further comprising a key chain.

3) The object holder of claim 1, further comprising a detachable key chain.

4) The object holder of claim 1, further comprising means for holding a key chain.

5) The object holder of claim 1, further comprising means for holding a detachable key chain.

6) An object holder system comprising:
a) a device defining a hole therein;
b) a nub removably attachable to said device; and
c) a frame having an upper portion and a lower portion, said upper portion being connected to said nub and said lower portion defining one or more holes therein.

7) The apparatus of claim 6, further comprising a key chain.

8) The apparatus of claim 6, further comprising a detachable key chain.

9) The apparatus of claim 6, further comprising means for holding a key chain.

10) The apparatus of claim 6, further comprising means for holding a detachable key chain.

11) The apparatus of claim 6, wherein said device is a chain door guard.

12) An object holder comprising:
a) one or more nubs; and
b) a container frame, having an upper portion and a lower portion, wherein said one or more nubs being connected to said upper portion and said lower portion defining one or more holes therein, said one or more holes for holding use.

13) The object holder of claim 12, wherein said container frame defining a plurality of holes.

14) The object holder of claim 12, further comprising means for holding other holder.

15) An object holder system comprising:
a) a device defining one or more holes therein;
b) one or more nubs removably attachable to said device defining one or more holes therein; and
c) a container frame, having an upper portion and a lower portion, wherein said one or more nubs being connected to said upper portion and said lower portion defining one or more holes therein, said one or more holes for holding use.

16) The apparatus of claim 15, wherein said frame defining a plurality of holes.

17) The apparatus of claim 15, wherein said device is a chain door guard.

18) The apparatus of claim 15, further comprising means for holding other holders.
